(19) United States
(12) Patent Application Publication
(10) Pub. No.: US 2026/0225669 A1
(43) Pub. Date: Aug. 6, 2026

(54) UNDERBODY PROTECTION MEANS FOR MOTOR VEHICLES, BATTERY HOUSING FOR A TRACTION BATTERY, TRACTION BATTERY FOR MOTOR VEHICLES, AND MOTOR VEHICLE HAVING AN UNDERBODY PROTECTION MEANS

(71) Applicant: KAUTEX TEXTRON GMBH & CO. KG, Bonn (DE)

(72) Inventor: Daniel HEIDRICH, Rommerskirchen (DE)

(73) Assignee: KAUTEX TEXTRON GMBH & CO. KG, Bonn (DE)

(21) Appl. No.: 19/160,291

(22) PCT Filed: Feb. 26, 2024
(86) PCT No.: PCT/EP2024/054770

§ 371 Date: Aug. 27, 2025

(30) Foreign Application Priority Data
Feb. 27, 2023 (DE) 10 2023 104 736.1

(51) Int. Cl. B62D 25/20; B60K 1/04

(52) U.S. Cl. CPC B62D 25/2072; B60K 1/04; B60K 2001/0438

(57) ABSTRACT

The present invention discloses an underbody protection means (1) for a motor vehicle, comprising at least one plastic layer (11, 12), at least one protection element (21, 22), and at least one foam layer (30), wherein the protection element (21, 22) is joined to the plastic layer (11, 12) and the foam layer (30) is joined to an inner surface (2) of the underbody protection means (1). The present invention also discloses: a battery housing having an underbody protection means (1) according to the invention; a traction battery having a battery housing according to the invention; and a motor vehicle having a traction battery according to the invention.

The present invention relates to an underbody protection means for vehicles, in particular electric vehicles. Furthermore, the present invention relates to a battery housing for a traction battery. Furthermore, the present invention relates to a traction battery for a motor vehicle. Finally, the present invention relates to a motor vehicle, in particular an electric motor vehicle with an underbody protection means.

Various types of underbody protection means are known from the prior art. Heavy steel plates or steel welded assemblies are mainly used as underbody protection means to absorb the high intrusion force and impact energy when vehicles dynamically hit obstacles. Such underbody protection systems increase the overall vehicle weight. In addition, underbody protection means made of steel pose an increased risk of corrosion. Finally, underbody protection means made of steel have low chemical resistance to components of battery cells and/or battery modules, in particular to electrolytes.

The invention is based on the object of providing an underbody protection means which has high rigidity and energy absorption capacity while at the same time being lightweight and which also has increased resistance to corrosion and chemical stress.

The underlying object of the present invention is achieved by an underbody protection means having the features of claim 1. Advantageous embodiments of the underbody protection means are described in the claims dependent on claim 1.

More specifically, the object underlying the present invention is achieved by an underbody protection means for a motor vehicle, which has at least one plastic layer, at least one protection element and at least one foam layer, wherein the protection element is joined to the plastic layer and the foam layer is joined to an inner surface of the underbody protection means.

The underbody protection means according to the invention has the advantage that the protective effect of the underbody protection means against mechanical impact, for example due to an impact, is increased and at the same time the weight of the underbody protection means is reduced. Furthermore, the underbody protection means according to the invention has improved corrosion resistance. Furthermore, the underbody protection means according to the invention has the advantage that it has an increased receiving volume in tight installation space conditions, in particular, in the vertical direction of a motor vehicle. If, for example, the underbody protection means according to the invention is used as a battery housing shell of a traction battery, the battery housing can be particularly flat.

The inner surface of the underbody protection means is the surface that faces a receiving volume of the underbody protection means.

The plastic layer preferably has a thickness dimension in a range between 1.5 mm and 5 mm, more preferably in a range between 2 mm and 3 mm. Again preferably, the plastic layer has a thickness of 2.5 mm.

The plastic layer is preferably made of a thermoplastic and/or thermosetting plastic.

The plastic layer may be designed, at least in sections, as a fiber-reinforced plastic layer. In addition, the flexural rigidity of the underbody protection means can be improved.

The plastic layer may contain short fibers and/or long fibers and/or continuous fibers. This can further improve the flexural rigidity of the underbody protection means.

The fibers of the plastic layer may be formed as glass fibers and/or carbon fibers and/or aramid fibers.

The plastic layer can be manufactured using pressing processes such as long-fiber thermoplastic extrusion, glass mat thermoplastic compression molding or injection molding.

The protection element preferably has a thickness in a range between 0.5 mm and 5 mm, more preferably in a range between 1 mm and 4 mm, more preferably in a range between 1.5 mm and 3 mm. Again preferably, the protection element has a thickness in the range of 0.8 mm and 1 mm.

Preferably, the protection element is detachable from the plastic layer so that in the event of damage to the protection element, it can be removed from the plastic layer and replaced with a new protection element.

Preferably, the at least one protection element is welded and/or glued and/or screwed to the at least one plastic layer.

The foam layer may be made of PUR foam. The foam layer may be made of EPP foam. The foam layer may be designed as a separately manufactured component.

Preferably, the foam layer has a density in a range between 60 g/l and 180 g/l, more preferably in a range between 100 g/l and 150 g/l.

Preferably, the underbody protection means is designed such that at least one protection element is arranged on an outer side of the underbody protection means and at least partially forms an outer surface of the underbody protection means. The at least one plastic layer is preferably arranged on an inner side of the underbody protection means and at least partially forms the inner surface of the underbody protection means and the foam layer is preferably at least in sections joined to the plastic layer.

The correspondingly designed underbody protection means has the advantage that, due to the arrangement of the protection element on the outer surface of the underbody protection means, any damage to the underbody protection means is easily visible, so that replacement of the underbody protection means or the protection element is simplified.

The outer side of the underbody protection means is the side facing away from the component on which the underbody protection means is arranged (e.g., traction battery). For example, if the underbody protection means is designed as a battery housing shell, the outer side of the underbody protection means is the side facing away from the receiving volume of the underbody protection means.

The outer surface of the underbody protection means is the surface that faces away from the receiving volume of the underbody protection means.

The inner side of the underbody protection means is the side that faces the component on which the underbody protection means is arranged (e.g., traction battery). For example, if the underbody protection means is designed as a battery housing shell, the inner side of the underbody protection means is the side that faces a receiving volume of the underbody protection means.

The foam layer may be glued and/or welded to the plastic layer, at least in sections.

Preferably, the underbody protection means has at least two plastic layers, wherein one of the plastic layers at least partially forms the inner surface of the underbody protection means. The protection element is preferably arranged in a sandwich-like manner between the two plastic layers and the foam layer is preferably joined at least in sections to the plastic layer which at least partially forms the inner surface of the underbody protection means.

An underbody protection means designed in this way has improved corrosion resistance.

One of the plastic layers is preferably arranged on an outer side of the underbody protection means and can at least partially form the outer surface of the underbody protection means. This means that the underbody protection means has even better corrosion resistance.

Preferably, the underbody protection means has at least two ribs that protrude into the foam layer.

The correspondingly designed underbody protection means has an even greater stability in the event of mechanical impact, which results, for example, from an impact caused by a dynamic landing of a motor vehicle on a surface.

Preferably, the foam layer has a thickness dimension that is greater than the height dimension of the at least two ribs. With a corresponding design, the respective free ends of the ribs are located within the foam layer. As a result, at least one battery cell and/or at least one battery module can be arranged more stably above the foam layer if the underbody protection means is designed as a battery housing shell.

The ribs may be arranged in a regular pattern. This improves the flexural rigidity of the underbody protection means.

For example, a first subset of the ribs may be aligned parallel to one another and a second subset of the ribs may be arranged in a crossed alignment with the first subset of the ribs.

The ribs may have a distance between them in a range between 30 mm and 400 mm, preferably in a range of 40 mm to 60 mm.

The ribs may have a wall thickness in a range of 1 mm to 5 mm, preferably in a range of 2 mm to 4 mm.

The ribs preferably have a height dimension in a range between 4 mm and 30 mm, more preferably in a range of 8 mm to 15 mm.

Preferably, at least a part of the ribs is formed monolithically with the plastic layer arranged on the inner side of the underbody protection means.

A correspondingly designed underbody protection means has the advantage that it can be manufactured in one piece.

Two monolithically connected components are fabricated from a single continuous piece. In particular, two monolithically connected parts are connected seamlessly.

Preferably, the underbody protection means is designed such that at least one protection element is arranged on an inner side of the underbody protection means and at least partially forms the inner surface of the underbody protection means. The at least one plastic layer is preferably arranged on an outer side of the underbody protection means and at least partially forms an outer surface of the underbody protection means and the foam layer is at least partially joined to the protection element.

The correspondingly designed underbody protection means has the advantage that the protection element is better protected against environmental influences, for example, and thus the underbody protection means has improved corrosion resistance.

The foam layer may be welded and/or glued at least in sections to the at least one protection element.

The at least one protection element, which at least partially forms the inner surface of the underbody protection means, may have a plurality of through-openings through which rib-forming material of the plastic layer protrudes. This allows an improved form fit between the at least one protection element and the plastic layer to be achieved. The correspondingly designed underbody protection means has improved stability and is also particularly easy to manufacture. This is because the position of the protection element arranged on the inner side facing the ribs is fixed by the ribs protruding through the through-openings. The ribs can be formed, for example, by pushing the material of the plastic layer through the through-openings of the protection element.

Preferably, the underbody protection means has at least two protection elements, wherein one of the protection elements at least partially forms the inner surface of the underbody protection means. The plastic layer is preferably sandwiched between the two protection elements and the foam layer is at least partially joined to the protection element, which at least partially forms the inner surface of the underbody protection means.

An underbody protection means designed in this way has improved flexural rigidity. Furthermore, the correspondingly designed underbody protection means has a reduced tendency to warp (deformation) when the temperature changes.

One of the protection elements is preferably arranged on an outer side of the underbody protection means and can at least partially form the outer surface of the underbody protection means. This means that the underbody protection means has even better flexural rigidity.

Preferably, the at least one protection element is designed as a metal plate or as an organic sheet or as a plastic element.

Organic sheets are fiber-matrix semi-finished products. These consist of a fiber fabric or a fiber nonwoven embedded in a thermoplastic plastic matrix. As a result, hot reshaping capability can be improved and thus fabrication times can be shortened. In addition, the flexural rigidity of the hybrid component can be improved.

If the protection element is designed as an organic sheet, it may contain long fibers and/or continuous fibers. This can further improve the flexural rigidity of the underbody protection means.

The fibers of the organic sheet may be glass fibers and/or carbon fibers and/or aramid fibers.

The organic sheet can be manufactured in a tool-ejecting manner using pressing processes such as long-fiber thermoplastic extrusion or glass mat thermoplastic compression molding.

The organic sheet may contain PA6 or PP. The organic sheet may contain the same plastic as the at least one plastic layer. This allows the organic sheet to be better joined to the plastic layer, in particular by welding.

If the underbody protection means has more than one protection element, one protection element may be designed as a metal plate and another protection element as an organic sheet.

If the protection element is designed as a metal plate, the metal plate may be made of aluminum or steel, for example.

The underbody protection means preferably has a connecting flange arranged on the edge.

Preferably, the protection element is joined to the plastic layer by means of a plurality of screws which is screwed into the connecting flange.

The screws are preferably designed as thread-forming screws, which form a thread in the plastic layer when screwed into it.

Preferably, the protection element is joined to the plastic layer by means of ten to eighty screws.

Preferably, a sealant is arranged between the protection element and the plastic layer, which sealant may be, for example, a one-component or two-component polyurethane adhesive or a silicone-based adhesive or an adhesive based on silane-modified polymers.

Preferably, an adhesive tape and/or a foam tape and/or a transfer tape, each preferably based on acrylic, is arranged between the protection element and the plastic layer.

Preferably, the connecting flange has a width dimension between 8 mm and 40 mm, preferably between 10 mm and 18 mm.

Preferably, at least one protection element is integrally joined to at least one plastic layer.

A material connection can be achieved, for example, by gluing the plastic layer to the protection element.

Preferably, an adhesion promoting layer is applied to the at least one protection element.

The adhesion promoting layer can achieve an improved bond, in particular an improved material bond.

The adhesion promoting layer may be a heat-activatable adhesive layer, preferably in the form of a film, a lacquer and/or a powder coating. The powder coating can be formed on a thermoplastic or thermosetting plastic basis. As a result, a further improved material-fitting connection between the at least one protection element and the at least one plastic layer can be achieved.

The adhesion promoting layer may have a layer thickness in a range of 0.02 mm to 3 mm, preferably in a range of 0.03 mm to 1 mm, more preferably in a range of 0.05 mm to 0.3 mm.

Preferably, the at least one protection element is welded to the at least one plastic layer.

Further preferably, the at least one protection element is microtextured. The micro texture of the contact surface of the at least one protection element is created, for example, by means of a laser micro texturing method and/or by means of sandblasting or corundum blasting and/or by means of an etching method. This allows a micro-form fit to be achieved between the at least one protection element and the at least one plastic layer.

A micro-form fit within the meaning of the invention is understood to mean a form fit between two components, wherein one component is at least partially engaged by the other component at a plurality of locations. As a result, an improved form fit with increased connection force can be achieved. In addition, as a result, two components made of different materials, such as plastic and metal, can be connected together more effectively.

Preferably, the underbody protection means is shell-shaped and at least partially delimits a receiving volume which is designed to accommodate battery cells and/or battery modules.

The correspondingly designed underbody protection means has the advantage that it combines several functions, namely the function of accommodating battery cells and/or battery modules and the function of protecting the battery cells and/or battery modules from damage caused by ground contact of a motor vehicle with a traction battery having the described underbody protection means.

Preferably, the foam layer is arranged in the receiving volume of the shell-shaped underbody protection means. This allows high intrusion forces and impact energy to be absorbed. If the underbody protection means is designed, for example, as a battery housing shell, at least one battery cell and/or at least one battery module can be better protected.

The object underlying the present invention is further achieved by a battery housing for accommodating battery cells and/or battery modules, wherein the battery housing has a battery housing shell which is designed as an underbody protection means described above according to one of the described embodiments.

The object underlying the present invention is further achieved by a traction battery for a motor vehicle, wherein the traction battery has at least one battery cell and/or at least one battery module and a battery housing as described above, wherein the at least one battery cell and/or the at least one battery module is/are arranged in the battery housing.

Preferably, the traction battery is designed such that the at least one battery cell and/or the at least one battery module is/are arranged on the foam layer.

In a traction battery designed in this way, the load distribution in the event of a vertical impact on the at least one battery cell and/or the at least one battery module arranged on the foam layer can be improved and, at the same time, the energy of the impact can be absorbed by the foam layer.

The object underlying the present invention is further achieved by a motor vehicle, in particular an electric motor vehicle, with an underbody protection means which is designed according to one of the embodiments described above and which is fastened to an underbody of the motor vehicle, in particular, to a traction battery of the motor vehicle. Alternatively, the object underlying the present invention is achieved by a motor vehicle, in particular, an electric vehicle with a traction battery which is designed according to one of the embodiments described above.

Further advantages, details, and features of the invention can be found below in the described exemplary embodiments. In the figures, in detail:

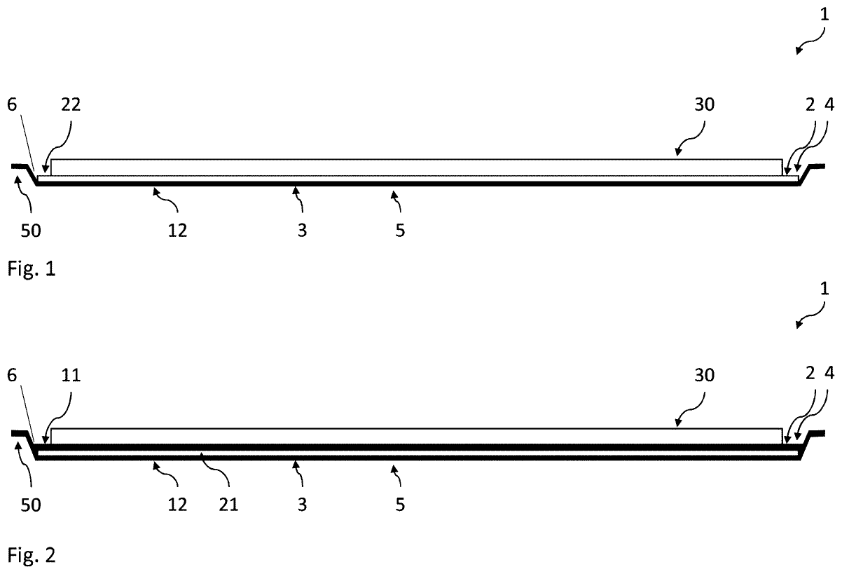

FIG. 1: shows a schematic sectional view of an underbody protection means according to the invention according to a first embodiment;

FIG. 2: shows a schematic sectional view of an underbody protection means according to the invention according to a second embodiment;

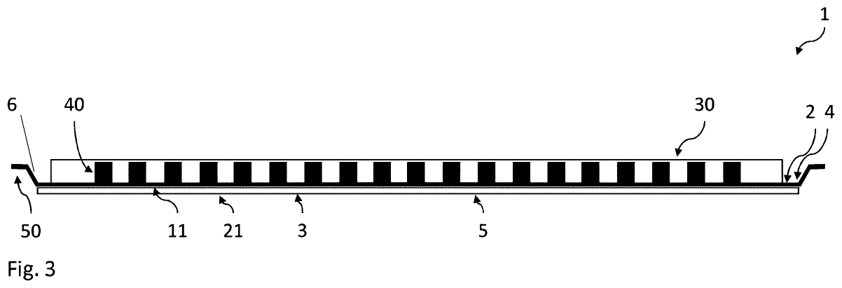

FIG. 3: shows a schematic sectional view of an underbody protection means according to the invention according to a third embodiment;

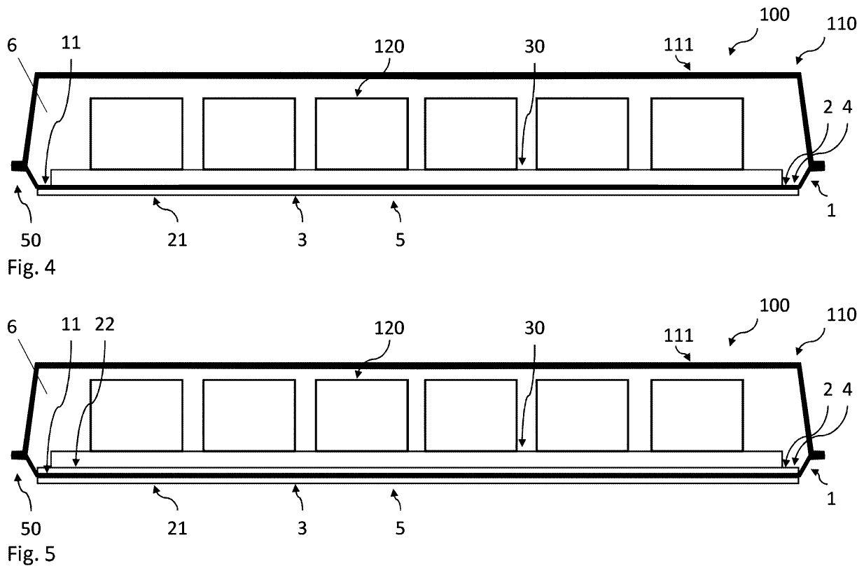

FIG. 4: shows a schematic sectional view of a traction battery according to the invention having an underbody protection means according to a fourth embodiment; and

FIG. 5: shows a schematic sectional view of a traction battery according to the invention having an underbody protection means according to a fifth embodiment.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

FIG. 1 shows a first embodiment of an underbody protection means 1 according to the invention for a motor vehicle in a schematic sectional view. The underbody protection means 1 has a plastic layer 12, a protection element 22 and a foam layer 30. The protection element 22 is joined to the plastic layer 12 and the foam layer 30 is joined to an inner surface 2 of the underbody protection means 1.

The protection element 22 is arranged on an inner side 4 of the underbody protection means 1 and at least partially forms the inner surface 2 of the underbody protection means 1. The plastic layer 12 is arranged on an outer side 5 of the underbody protection means 1 and at least partially forms an outer surface 3 of the underbody protection means. The foam layer 30 is at least partially joined to the protection element 22.

The underbody protection means 1 also has a connecting flange 50 arranged on the edge. The connecting flange 50 may have a width dimension between 8 mm and 40 mm.

The underbody protection means 1 is further shell-shaped and at least partially delimits a receiving volume 6 which is designed to accommodate battery cells 120 and/or battery modules.

The at least one protection element 22 may be designed as a metal plate or as an organic sheet. The at least one protection element 22 may be integrally joined to the plastic layer 12.

FIG. 2 shows a second embodiment of an underbody protection means 1 according to the invention for a motor vehicle in a schematic sectional view. The underbody protection means 1 has two plastic layers 11, 12, wherein one of the plastic layers 11 at least partially forms the inner surface 2 of the underbody protection means 1. The protection element 21 is arranged in a sandwich-like manner between the two plastic layers 11, 12 and the foam layer 30 is at least partially joined to the plastic layer 11, which at least partially forms the inner surface 2 of the underbody protection means 1. Additionally, one of the plastic layers 12 is arranged on an outer side 5 of the underbody protection means 1 and at least partially forms an outer surface 3 of the underbody protection means.

The at least one protection element 21 may be designed as a metal plate or as an organic sheet. The at least one protection element 21 may be integrally joined to the plastic layer 11 and/or to the plastic layer 12.

FIG. 3 shows a third embodiment of an underbody protection means 1 according to the invention for a motor vehicle in a schematic sectional view. The underbody protection means 1 has a protection element 21 which is arranged on an outer side 5 of the underbody protection means 1 and at least partially forms an outer surface 3 of the underbody protection means 1. The plastic layer 11 is arranged on an inner side 4 of the underbody protection means 1 and at least partially forms the inner surface 2 of the underbody protection means 1 and the foam layer 30 is at least partially joined to the plastic layer 11.

The underbody protection means 1 also has at least two ribs 40 which protrude into the foam layer 30. At least part of the ribs 40 may be formed monolithically with the plastic layer 11, which is arranged on the inner side 4 of the underbody protection means 1.

FIG. 4 shows a traction battery 100 according to the invention for a motor vehicle in a schematic sectional view. The traction battery 100 has at least one battery cell 120 and a battery housing 110, wherein the at least one battery cell 120 is arranged in the battery housing 110.

The battery housing 110 has a battery housing cover 111 and an underbody protection means 1 designed as a battery housing shell 1 according to a fourth embodiment. The underbody protection means 1 has a plastic layer 11, a protection element 21 and a foam layer 30. The protection element 21 is joined to the plastic layer 11 and the foam layer 30 is joined to an inner surface 2 of the underbody protection means 1.

The protection element 21 is arranged on an outer side 5 of the underbody protection means 1 and at least partially forms an outer surface 3 of the underbody protection means 1. The plastic layer 11 is arranged on an inner side 4 of the underbody protection means 1 and at least partially forms the inner surface 2 of the underbody protection means 1 and the foam layer 30 is at least partially joined to the plastic layer 11.

The underbody protection means 1 also has a connecting flange 50 arranged on the edge. The underbody protection means 1 is shell-shaped and at least partially delimits a receiving volume 6 which is designed to accommodate battery cells 120 and/or battery modules.

The battery housing cover 111 is joined to the underbody protection means 1 by the connecting flange 50 and limits the receiving volume 6.

The at least one battery cell 120 is arranged on the foam layer 30. The at least one battery cell 120 is arranged in the receiving volume 6.

FIG. 5 shows a traction battery 100 according to the invention for a motor vehicle in a schematic sectional view. The traction battery 100 has at least one battery cell 120 and a battery housing 110, wherein the at least one battery cell 120 is arranged in the battery housing 110.

The battery housing 110 has an underbody protection means 1 designed as a battery housing shell 1 according to a fifth embodiment. The underbody protection means 1 has a plastic layer 11, two protection elements 21, 22 and a foam layer 30. The protection element 22 at least partially forms the inner surface 2 of the underbody protection means 1 and the plastic layer 11 is arranged in a sandwich-like manner between the two protection elements 21, 22. The foam layer 30 is at least partially joined to the protection element 22, which at least partially forms the inner surface 2 of the underbody protection means 1.

The protection element 21 is arranged on an outer surface 5 of the underbody protection means 1 and at least partially forms an outer surface 3 of the underbody protection means 1.

The plastic layer 11 may be integrally joined to the protection element 21 and/or the protection element 22.

### LIST OF REFERENCE SIGNS

1 Underbody protection means/battery housing shell
2 Inner surface (of the underbody protection means)
3 Outer surface (of the underbody protection means)
4 Inner side (of the underbody protection means)
5 Outer side (of the underbody protection means)
6 Receiving volume (receiving volume)
11 (First) plastic layer
12 (Second) plastic layer
21 (First) protection element/metal plate/organic sheet
22 (Second) protection element/metal plate/organic sheet
30 Foam layer/layer of foam/foam material
40 Rib
50 Connecting flange
100 Traction battery
110 Battery housing
111 Battery housing cover
120 Battery cell

1. An underbody protection means for a motor vehicle, having:
at least one plastic layer;
at least one protection element; and
at least one foam layer, wherein the protection element is joined to the plastic layer; and
the foam layer is joined to an inner surface of the underbody protection means.

2. The underbody protection means according to claim 1, characterized by the following features:
at least one protection element is arranged on an outer side of the underbody protection means and at least partially forms an outer surface of the underbody protection means;
the at least one plastic layer is arranged on an inner side of the underbody protection means and at least partially forms the inner surface of the underbody protection means; and
the foam layer is at least partially joined to the plastic layer.

3. The underbody protection means according to claim 1, characterized by the following features:
the underbody protection means has at least two plastic layers, one of the plastic layers at least partially forming the inner surface of the underbody protection means;
the protection element is sandwiched between the two plastic layers; and
the foam layer is at least partially joined to the plastic layer which at least partially forms the inner surface of the underbody protection means.

4. The underbody protection means according to claim 2, characterized in that the underbody protection means has at least two ribs which protrude into the foam layer.

5. The underbody protection means according to claim 4, characterized in that at least some of the ribs are formed monolithically with the plastic layer arranged on the inner side of the underbody protection means.

6. The underbody protection means according to claim 1, characterized in that
at least one protection element is arranged on an inner side of the underbody protection means and at least partially forms the inner surface of the underbody protection means;
the at least one plastic layer is arranged on an outer side of the underbody protection means and at least partially forms an outer surface of the underbody protection means; and
the foam layer is at least partially joined to the protection element.

7. The underbody protection means according to claim 1,
characterized by the following features:
the underbody protection means has at least two protection elements, one of the protection elements at least partially forming the inner surface of the underbody protection means;
the plastic layer is sandwiched between the two protection elements; and
the foam layer is at least partially joined to the protection element, which at least partially forms the inner surface of the underbody protection means.

8. The underbody protection means according to claim 1, characterized in that the at least one protection element, is designed as a metal plate or as an organic sheet or as a plastic element.

9. The underbody protection means according to claim 1, characterized in that the underbody protection means has a connecting flange arranged on the edge.

10. The underbody protection means according to claim 1, characterized in that at least one protection element is integrally joined to at least one plastic layer.

11. The underbody protection means according to claim 1, characterized in that the underbody protection means is shell-shaped and at least partially delimits a receiving volume which is designed to accommodate battery cells and/or battery modules.

12. A battery housing for accommodating battery cells and/or battery modules, comprising a battery housing shell designed as underbody protection means according to claim 1.

13. A traction battery for a motor vehicle, comprising at least one battery cell and/or at least one battery module and a battery housing according to claim 12, wherein the at least one battery cell and/or the at least one battery module is/are arranged in the battery housing.

14. The traction battery according to claim 13, characterized in that the at least one battery cell and/or the at least one battery module is/are arranged on the foam layer.

15. A motor vehicle, having an underbody protection means according to claim 1, which is attached to an underbody of the motor vehicle.
